(19) United States
(12) Patent Application Publication
(10) Pub. No.: US 2005/0021858 A1
(43) Pub. Date: Jan. 27, 2005

(54) Network conduit for providing access to data services

(76) Inventors: Jeremy Waine Ruston, London (GB); Ray John Eitel-Porter, New York, NY (US); Christopher William Birkle, London (GB); Richard Anthony Conway, Essex (GB)

Correspondence Address: Edward J Chalfie;Arnstein & Lehr, Suite 1200, 120 South Riverside Plaza, Chicago, IL, 60606, US

(21) Appl. No.: 10/467,100

(22) PCT Filed: Feb. 11, 2002
(86) PCT No.: PCT/GB02/00602

(30) Foreign Application Priority Data
Feb. 9, 2001 (WO) PCT/GB01/00523

(51) Int. Cl. G06F 15/16

(52) U.S. Cl. 709/246

(57) ABSTRACT

A web service conduit (3) receives data access requests from browsers (11) from hyperlinks on pages generated by web sites (4), converts the data access requests to web service access requests, and invokes the corresponding web services (40) with the web service access requests.

### FIELD OF THE INVENTION

The present invention relates to a system for providing access to network data services. The present invention has particular but not exclusive applications to a method of facilitating access to web services by web sites.

### BACKGROUND OF THE INVENTION

Web services are a class of computer program that runs on a server computer connected to the Internet. Instead of using protocols such as HTTP and FTP to communicate with a user, web services are invoked by other programs which may be running on clients or other servers connected to the Internet. Web services may use an XML-based protocol such as SOAP, with a transport protocol such as HTTP.

In a conventional architecture shown in FIG. 1, a client browser 11 accesses web pages over the Internet 14 on a web site 4, which invokes one or more web services 40 over the Internet 14 as part of the page generation process. Taking for example a web-based timetable lookup service, the user of the client browser 11 downloads a form page from the server 4 and fills in the lookup details of a timetable request. When the form is submitted, the client browser 11 sends a page request including the lookup details to the web site 4 using HTTP. The web site 4 invokes an underlying timetable lookup web service 40 using HTTP to get the data requested by the user, and formats the XML result into a form to be returned in a web page to the browser 11.

This architecture gives great flexibility, and allows the functionality of complex web sites to be distributed as underlying web services across geographic and commercial boundaries. However, there are certain technical requirements for the web site 4 to be able to invoke web services 40: it must be able to make outgoing HTTP requests and to handle XML, SOAP and other protocols. These requirements can be a significant barrier to the use of web services. Furthermore, there is a great deal of freedom of data formats and protocols within web service standards such as HTTP, SOAP and XML, which makes the migration from one web service to another very difficult for a web site operator.

### STATEMENT OF THE INVENTION

According to one aspect of the present invention, there is provided a web service conduit which receives data access requests from browsers on pages generated by web sites, converts the data access requests to web service access requests, and invokes the corresponding web services with the web service access requests.

The web service access requests may be requests to read and/or write data. In the case of a read data request, the web service conduit receives data read from the web service, converts it into a browser format and sends it to the browser.

An advantage of the invention is that web site authors can implement web services using a standard format required by the web service conduit, without the technical requirements of the different underlying web services. For example, there will be no need to enable outgoing HTTP at the web site, or to use XML or SOAP.

### BRIEF DESCRIPTION OF THE DRAWINGS

Specific embodiments of the present invention will now be described with reference to the accompanying drawings, in which:

FIG. 1 is a diagram of a conventional web service architecture;

FIG. 2 is a diagram of a web service architecture in a general embodiment of the present invention;

FIG. 3 is a diagram of the steps in a read operation in an embodiment of the present invention;

FIG. 4 shows a web form as displayed on a browser for initiating the read operation;

FIG. 5 shows a log-in form as displayed by the browser during the read operation;

FIG. 6 shows a trusted web service check form as displayed by the browser during the read operation;

FIG. 7 is a diagram of the steps in a write operation in an embodiment of the present invention; and

FIG. 8 shows a web page displaying details of an event and a hyperlink to add the event to a web-based calendar.

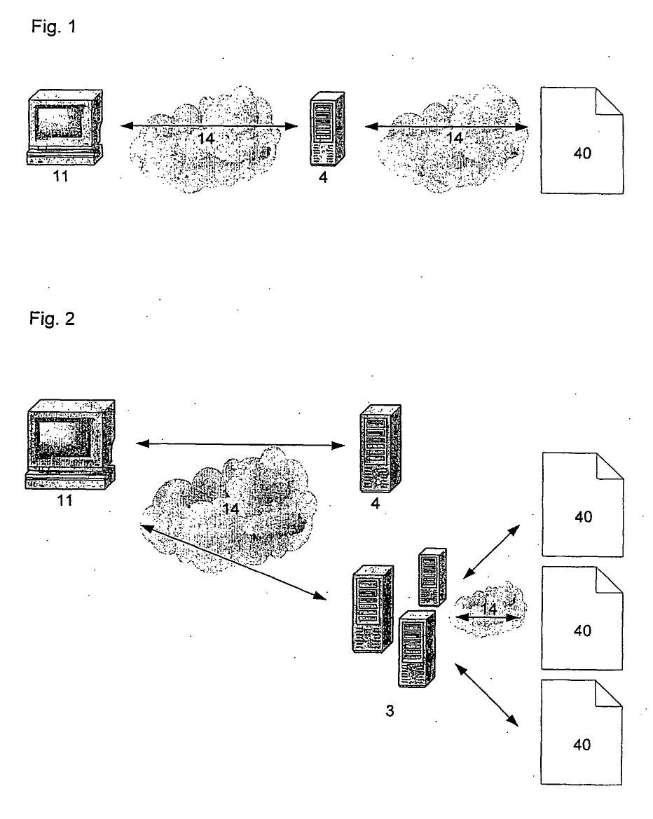

### MODES FOR CARRYING OUT THE INVENTION

### GENERAL EMBODIMENT

A general embodiment of the present invention is shown in FIG. 2. In this architecture, web pages on the web site 4 include links to a conduit 3 connected to the Internet 14. The links cause the conduit 3 to invoke one or more underlying web services 40 over the Internet 14 to perform data read and/or write operations. In a read operation, the conduit 3 forwards data read from one of the web services to the browser 11. In a write operation, the data written to one of the web services 40 may be subsequently accessed by a read operation, or via another web server (not shown).

As is well known, the web site 4 may be implemented by one or more web servers each comprising one or more computers connected to the Internet and running a web application on a web server platform.

The web services 40 may be implemented by one or more application servers which comprise one or more computers connected to the Internet and running application server software serving as an interface or ‘middleware’ to one or more databases. The databases need not be collocated with the application servers but may instead be hosted at remote sites. However, the connections to the databases typically take place over high-bandwidth low-latency networks and not over the Internet. An example of a web service is the Microsoft .NET™ web services.

The browser 11 may be implemented by a computer connected directly or indirectly to the Internet 14 and running browser software such as Microsoft™ Internet Explorer™ or Netscape™ Navigator versions 3 or above. The computer may be a desktop, laptop or palmtop computer or any other similar device which is capable of running browser software and connecting to the Internet. The computer may be connected to the Internet indirectly via a wireless circuit-switched or packet-switched network.

The conduit 3 may be implemented by any suitable server configuration, but preferably by a secure, scalable, fault-tolerant server farm running a custom conduit application on suitable platform, such as Linux.

The present invention is not limited to these specific configurations and may be implemented using other types of computer, device and/or network.

Read Operation

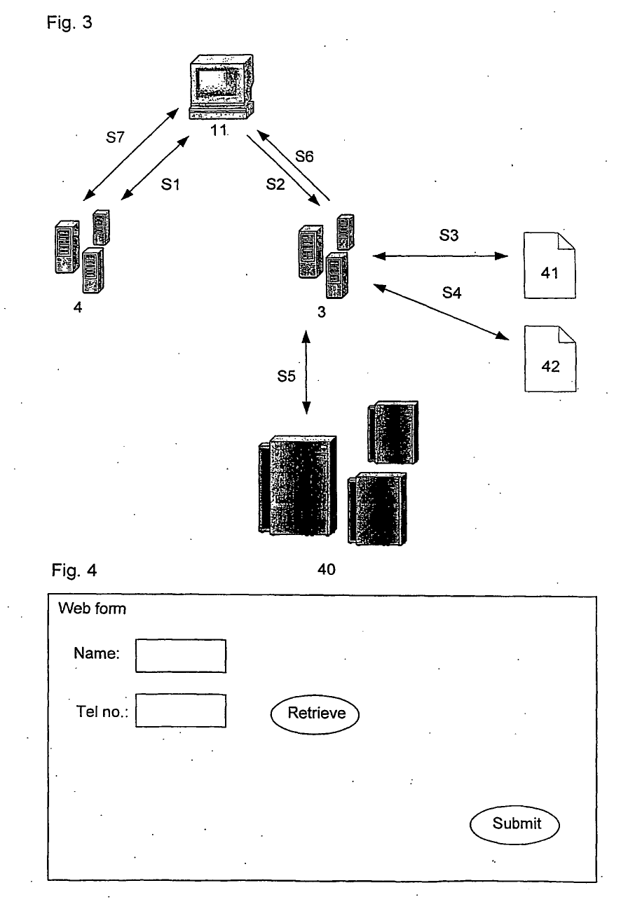

An example of a read operation in a first specific embodiment of the present invention will now be described with reference to FIGS. 3 to 6. In this example, a form is populated with data retrieved from a user profile web service.

At step S1, the user of the browser 11 requests a page from a web site 4, which returns a form with blank fields. For example, as shown in FIG. 4, the page includes fields for the user's name and telephone number. The page includes a ‘Retrieve’ button which contains a link to the conduit 3 including parameters for passing to the conduit 3. The parameters include the identity of the web service 40, the identity of the web site 4, and the names of fields to be read from the web service 40.

In this example, the user has already stored a full set of details, including name and address, on a web service 40. Rather than enter the details manually, the user clicks on the ‘Retrieve’ button. At step S2, the browser 11 is redirected to the conduit 3 and the parameters embedded in the link are passed to the conduit 3.

The conduit 3 must authenticate the user and ensure that the user is authorized to access the requested web service. This may be done by verifying that the user is logged in to a user authentication service such as the Microsoft™ .NET Passport. Alternatively, the conduit 3 may use a separate authentication system from the web services 40. If the user is already authenticated, then the operation passes directly to step 4 and the user may read the authentication details stored on the user's computer, for example as an encrypted cookie.

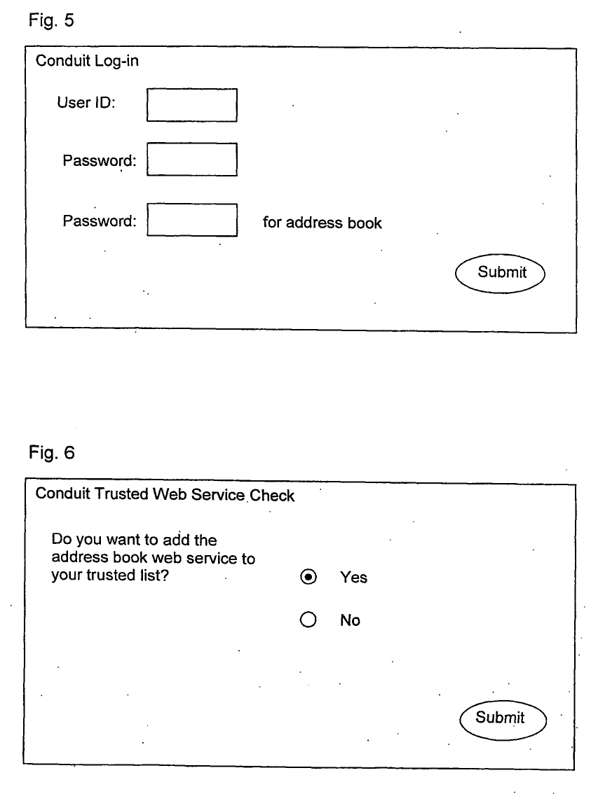

If the user is not logged in, at step S3 the conduit 3 sends a page 41 to the browser 11 requesting the user to log in to the conduit 3 and optionally the relevant web service 40, if this is required. An example of this page is shown in FIG. 5. If it is the first visit of the user to the conduit 3 the user may be prompted for a choice of authentication mechanism for the desired category of the read/write web service access. For example, if the user selects .NET Passport to retrieve their profile, then the elected web service will be .NET Profile. This setting may be changed subsequently by the user. Preferably, the conduit 3 generates a separate pop-up window at the browser 11 for communication with the user, so as not to remove the page of the web site 4 from display.

At step S4, the conduit 3 checks the identity of the indicated web service 40 against a list 42 of web services to which the user has granted the conduit 3 permission to access. If the indicated web service is not on this list, the conduit 3 sends a page to the browser 11 prompting the user to add the indicated web service 40 to the user's list 42, as shown for example in FIG. 6. If the user agrees to add the indicated web service to the list 42 then the process continues. Otherwise, the process terminates and the conduit 3 sends a page to the browser 11, preferably in a pop-up window, indicating that the web service 40 cannot be used. At step S5, the conduit 3 sends a read request to the web service 40 using the parameters supplied in the link by the browser 11. The read request is formatted by the conduit 3 according to the protocols required by the web service. The conduit 3 receives the requested data from the web service 40.

At step S6, the conduit 3 formats the received data and forwards it to the browser 11. At step S7, the browser 11 is redirected to the web site 4 with the received data encoded within the query string and the user submits the completed form to the web site 4.

As an alternative to step S6, the conduit 3 may send the received data to the browser 11 as a form POST with the received data encoded in the HTTP request body.

Web Site Implementation

To implement a read operation link, three HTML fragments must be incorporated in the web site 4: a JavaScript HTML tag, an Onload event in the HTML body tag, and the hyperlink to the conduit 3.

In one example, the JavaScript HTML tag is:

<SCRIPT LANGUAGE=“javascript”
SRC=http://conduitserver.com/scripts/conduit_read.js></SCRIPT>

The file requested by this HTML tag contains a single generic function, for example WriteFormValues, to manage the form data requirements and any state data including any application-specific query string or hidden field data present on the web site 4.

The JavaScript function first checks to see if there is a query string argument. If so, and none of the names within the query string name-value pairs correlate to form field names on the web page, then the query string text is appended to the end of the hyperlink to the conduit 3. Similarly, any hidden field data in the page is copied into the hyperlink to the conduit 3.

When returning to the page, the JavaScript function initially associates form fields (either text box or application-defined hidden fields) with name-value pairs within the query string. Any query string information needed for proprietary purposes of the web site 4 is left unimpaired by the conduit 3 so as not to interfere with any web site server script which runs as a prelude to the delivery of the page. A sample script for WriteFormValues is given in Annex 1 below. This script is compatible with JavaScript DOM implementation in third-generation browsers (e.g. Microsoft™ Internet Explorer™ 3.00 and above or Netscape™ Navigator™ 3.00 and above).

To copy the values from the page parameters to the associated fields, the function WriteFormValues is invoked using the OnLoad event in the HTML BODY tag, for example:
OnLoad=“WriteFormValues( )”

Finally, a hyperlink to the conduit 3 is included in the form page to allow the user to invoke the web service 40 via the conduit 3. The hyperlink may be associated with an icon allowing the user to identify a link to the conduit 3. For example, the hyperlink may be coded as:

```
  <A HREF = “http://conduitserver.com/conduitrequest.aspx
  ?name=con_profile_name&telno=con_profile_telno&con_pid=1234
>
  <IMG SRC=http://conduitserver.com/images/request.gif
BORDER=“0”></A>
```

The URL contains a list of parameters used by the conduit 3, where Name and Telno refer to the form text boxes with fieldnames Name and Telno respectively. PID is a partner identifier which identifies the web site 4 to the conduit 3. The parameter names are preferably those recognised by the web service 40, prefixed with ‘con_’ to represent the encoded version for the conduit 3.

In some cases, additional parameters may need to be sent to the conduit 3 for supply to the web service 40. For example, the web service may require an email address of the user. This information is extracted by the JavaScript from either hidden field information or from a textbox on the form page, and the name-pair field is sent to the conduit 3. The conduit 3 recognises this field because of the ‘con_’ prefix before the actual parameter name recognised by the web service 40.

Write Operation

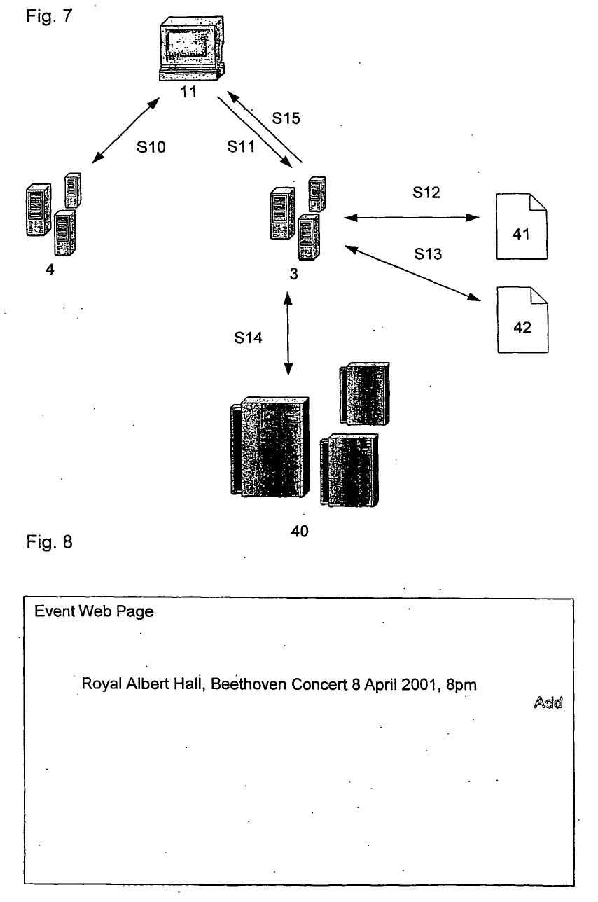

An example of a write operation in a second embodiment of the present invention will now be described with reference to FIGS. 7 and 8. This embodiment uses the same general architecture as shown in FIG. 2. In this example, the user adds the details of an event to a web calendar service.

At step S10, the user of the browser 11 requests a page from a web site 4, which displays details of an event with a hyperlink to add that event to the user's calendar. For example, as shown in FIG. 8, details of a concert are displayed with an ‘Add’ button alongside.

At step S11, the user clicks on the ‘Add’ button and the browser is redirected to the conduit 3 by the underlying hyperlink. The hyperlink comprises the URL of the conduit 3 together with parameters which include the identity of the web service 40, the identity of the web site 4, and the names and values of the fields to be written to the web service 40. These parameters are passed to the conduit 3.

If the user is not already authenticated, at step S12 the conduit 3 prompts the user to log in, as in the read operation.

At step S13, the conduit 3 checks the identity of the indicated web service 40 against a list 42 of web services to which the user has granted the conduit 3 permission to access. If the indicated web service is not on this list, the conduit 3 sends a page to the browser 11 prompting the user to add the indicated web service 40 to the user's list 42. If the user agrees to add the indicated web service to the list 42 then the process continues. Otherwise, the process terminates and the conduit 3 sends a page to the browser 11 indicating that the web service 40 cannot be used.

At step S14, the conduit 3 send parameter values derived from the parameter values in the hyperlink to the web service 40, and the web service responds by confirming that the values have been added to the user's calendar. At step S15, the conduit 3 displays a page, such as a pop-up window, confirming that the details of the event have been added to the user's calendar.

Web Site Implementation

To implement a write operation link, only a correctly formatted hyperlink is required in the displayed page at the web site 4. For example:

```
  <A HREF=“http://conduitserver.com/
  ?con_pid=1234&con_eid=5678&con_day=08&con_month=04&con_{—}
year=2001&con_starttime=20.00&con_subject=beethoven@royal_{—}
albert_hall>
  <IMG SRC=http://conduitserver.com/images/add.gif
  BORDER=“0”></A>
```

The hyperlink contains the names and values of parameters recognised by the web service, with the names prefixed by ‘con_’ so that the conduit 3 can identify parameters which it must forward to the web service 40.

Alternatively, an address-based hyperlink may be used, such as:
http://conduitserver.com/pid=1234/eid=5678/08/04/2001/20.00/beeth oven@royal_albert_hall>
   Conduit Implementation for Read/Write Operation

The following description applies to both read and write operations and hence to both the first and second embodiments.

The conduit 3 has access to a web service database identifying the format and protocol requirements of available web services 40, as well as their service types and field definitions. The conduit 3 is therefore able to translate a generic access request from the browser 11 to an access request to a specific web service 40.

The conduit 3 also has access to a user database identifying, for each registered user, the web services 40 to which the user has granted permission to access, together with user logon details such as UserID and password.

In each web service access request, the conduit 3 receives the parameters from the browser 11 and identifies those with the “con_” prefix as requiring processing. The conduit 3 identifies the requested web service type from the service type prefix of the parameters; for example, “profile_” indicates a user profile server type. Those parameters without a service type prefix, such as PID, are for internal processing by the conduit 3 and are not passed to a web service.

The conduit 3 then identifies a specific web service 40 by searching the specified user record of the user database for a permitted web service of the specified web service type. The conduit reads the requirements of the specific web service 40 from the web service database, and formats and sends the parameters relevant to that web service 40 according to those requirements.

The present invention is not limited to the general or specific embodiments described above. It is envisaged that various modifications and variations could be made without falling outside the scope of the present invention.

Annex 1—Sample JavaScript Function

```
function WriteFormValues( ) {
  var queryString = document.location.href;
  var twoQueryString = queryString.split(“?”);
  if(twoQueryString.length<=1) return;
  var eachFormElement = twoQueryString[1].split(“&”);
  var m_NameValue = new Array( );
  //Search through hidden fields here
  //On the return trip the hidden fields will be pulled back out and
  //reloaded into form element values
  for(int a = 0; a < details.elements.length; i++) {
    if(details.elements[i].type==“hidden”) {
      m_NameValue[details.elements[i].name] = details.elements[i].
      value;
    }
  }
  //Do form handling here
  var details = document.forms[0];
  var selected = false;
  for(i = 0; i < details.elements.length; i++) {
    if(details.elements[i].type==“text” ∥ details.elements[i].type==
    “hidden”) {
      for(var j = 0; j < eachFormElement.length; j++) {
        var tempString = eachFormElement[j].split(“=”);
        if(tempString[0] == details.elements[i].name) {
          details.elements[i].value=tempString[1];
          selected = true;
          break;
        }
      }
    //Do the capturing of querystring information here - if the name from
    the
    //name-value pair doesn't correspond to a form element then the
values will be
      //appended to the link querystring
      if(selected==false) {
        m_NameValue[tempString[0]] = tempString[1];
      }
      selected = false;
    }
  }
  //Add to conduit link
  var addQuery = “&”;
  for(key in m_Name) {
    addQuery += (key + “=” + m_NameValue[key] + “&”);
  }
  document.all[“Link”].href += addQuery.substring(0, addQuery.length −
  1);
  return true;
}
```

Annex 2—Glossary
DOM: Document Object Model which allows JavaScript to interact with objects on an HTML page to change their behaviour.
HTTP: HyperText Transport Protocol. The standard World Wide Web client-server protocol user for the exchange of information (such as HTML documents, and client requests for such documents) between a browser and a web server.
HTML: HyperText Markup Language. A standard coding convention and set of codes for attaching presentation and linking attributes to informational content within web pages. During a web page authoring stage, the HTML codes are embedded within the informational content of the web page. When the web page is subsequently downloaded to a browser, the codes are interpreted by the browser and user to parse and display the web page. HTML codes are often used to create links to other web pages, commonly referred to as “hyperlinks”.
JavaScript: A platform-independent scripting language which can interact with HTML to provide additional browser functionality.
.NET: An operating system platform developed by Microsoft, which allows applications to be hosted on remote servers over the Internet.
Passport: A standardized authentication system for NET which allows users to be authenticated to multiple different services using a single set of authentication details.
SOAP: Simple Object Access Protocol. A platform-independent protocol for sending information over the Internet. SOAP uses an XML format with HTTP as a transport protocol,
XML: Extensible Markup Language. A specification for designing customized tags (HTML codes), enabling the definition, transmission, validation and interpretation of data between applications and between organisations.

1. A method of providing access to a remote data service (40) over a network (14), comprising:
a. receiving (S2; S11) from a remote terminal (11) a data access request, in a first format, identifying one or more parameters;
b. converting the data access request into a second format; and
c. forwarding (S5; S14) the data access request in the second format to the remote data service so as to perform a data access using the parameters;
wherein the data access request is forwarded by the terminal (11) from a network service (4) remote from the terminal (11) and from the data service (40).

2. The method of claim 1, wherein the data access request is a read access request, the method further comprising:
d. receiving (S5) from the remote data service (40), in said second format, a data message containing parameter values corresponding to the parameters identified in said data access request;
e. converting the data message from said second format to said first format; and
f. forwarding (S6) the data message in the first format to the remote terminal (11).

3. The method of claim 2, wherein the data access request is a write access request and contains parameter values corresponding to the parameters, and step c causes the parameter values to be written to the data service (40).

4. A method of providing access to a web service (40) over the Internet (14), comprising:
a. receiving (S2; S11) from a browser (11) a data access request, in a first format, identifying one or more parameters;
b. converting the data access request into a second format; and
c. forwarding (S5; S14) the data access request in the second format to the web service (40) so as to perform a data access using the parameters;
wherein the data access request is forwarded by the browser (I 1) from a web site (4) remote from the web service (40).

5. A method of providing access to a remote data service (40) over a network (14) using a link protocol, comprising sending to a remote terminal (11) a link to a network conduit (3), the link identifying one or more parameters and being formatted so as to cause the network conduit (3) to perform a data access at the remote data service (40) using the parameters when forwarded to the network conduit (3) by the remote terminal (11).

6. The method of claim 5, wherein the link is formatted to provide a data read access at the remote data service (40) such that parameter values corresponding to the parameters are read (S5) from the data service (40) by the network conduit (3) and are forwarded to the remote terminal (11).

7. The method of claim 6, further comprising sending to the remote terminal (11) a link to a program to cause the program to be loaded and executed by the remote terminal (11) so as to control the handling of the data read access by the terminal (11).

8. The method of claim 7, further including the step of receiving the parameter values from the remote terminal (11).

9. The method of claim 5, wherein the link is formatted to provide a data write access at the remote data service (40) and includes parameter values corresponding to the parameters, such that the parameter values are written to the data service (40) by the network conduit (3).

10. A method of providing access to a web service (40) over the Internet (14), comprising sending to a browser (11) an HTML link to a conduit (3), the link identifying one or more parameters and being formatted so as to cause the network conduit (3) to perform a data access at the web service (40) using the parameters when forwarded to the conduit (3) by the browser (11).

11. A method of performing a data access operation at a remote data service (40) over a network (14) from a terminal (11) using a link protocol, including:
a. receiving (S1; S10) at the terminal (11) from a network service (4) a link directed to a network conduit (3) and identifying one or more parameters; and
b. in response to user activation of the link, connecting (S2) the terminal (11) to the network conduit (3) over the network (14) and identifying the parameters to the network conduit (3), such that the parameters are forwarded by the network conduit (3) to the remote data service (40) so as to perform the data access operation.

12. The method of claim 11, wherein the data access operation is a read access operation, the method further including receiving (S6) parameter values corresponding to the parameters from the network conduit (3).

13. The method of claim 12, further including forwarding (S7) the parameter values to the network service (4).

14. The method of any one of claims 11 to 13, including receiving a link to a program, the link causing the program to be loaded and executed by the terminal (11) so as to control the handling of the read access operation by the terminal (11).

15. The method of claim 11, wherein the data access operation is a write access operation, and the link includes parameter values corresponding to the identified parameters, whereby the parameter values are written to the remote data service (40) by the network conduit (3).

16. A method of performing a web service access operation over the Internet (14) from a browser (11), including:
a. receiving (S1; S10) at the browser (11) from a web site (4) a hyperlink to a conduit (3), the hyperlink identifying one or more parameters; and
b. in response to user activation of the hyperlink, connecting (S2) the browser (11) to the conduit (3) over the Internet (14) and identifying the parameters to the conduit (3), such that the parameters are forwarded by the conduit (3) to the web service (40) so as to perform the data access operation.

17. A computer program for performing the method of any preceding claim.

18. A carrier bearing a computer program according to claim 17.

19. A system for providing access to a data service (40) over a network (14) using a link protocol, comprising:
a. a network service (4) which provides a link to a conduit (3) including one or more parameters;
b. a terminal (11) which receives said link and, in response to a user selection, sends the one or more parameters to the conduit (3); and
c. said conduit (3) which receives said one or more parameters and sends a data access request including said one or more parameters to the data service (40) over the network (14).
